(19) United States
(12) Patent Application Publication
(10) Pub. No.: US 2004/0105457 A1
(43) Pub. Date: Jun. 3, 2004

(54) Secure method of exchanging information messages

(75) Inventor: Michel Linares, Colombes (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM

(21) Appl. No.: 10/677,273

(22) Filed: Oct. 3, 2003

(30) Foreign Application Priority Data
Oct. 7, 2002 (FR) 02 12 404

(51) Int. Cl. H04B 7/216

(52) U.S. Cl. 370/441

(57) ABSTRACT

A secure method of exchanging information messages sent successively from a sending platform to a receiving platform includes:

a) an initialization sequence in which an initialization message M₀ containing information relating to a date t₁ for sending a first information message M₁ is exchanged between the sending platform and the receiving platform, and

b) an information message transmission sequence in which:

the information messages are sent successively by the sending platform at given time intervals ΔT_{E}, each message Mₙ being coded by means of a dynamic code Cₙ specific to the date tₙ of sending the message, and

the messages received by the receiving platform are processed as a function of their reception date tᵣ so that the messages received in an observation window Fₙ in the vicinity of tₙ are decoded using a decoding sequence DCₙ adapted to decode the dynamic code Cₙ, the clock of the receiving platform being synchronized to the date t₁ on receiving the first message M₁.

### BACKGROUND OF THE INVENTION

1. Field of the Invention

The invention relates to a secure method of exchanging information messages sent successively, at given time intervals, from a sending platform to a receiving platform. The invention relates more particularly to a method which ensures that the last message picked up by the receiving platform corresponds to the last message sent by the sending platform.

2. Description of the Prior Art

The method according to the invention finds one application in train control and/or supervision systems, which are known in France as control, operation and maintenance aid systems (SACEM) and include a centralized control station, fixed installations along the tracks, and a control unit in each train. In control systems of this kind, the centralized control station sends the fixed installations at regular time intervals information messages including information relating to traffic conditions on one or more track sections downstream of the fixed installation. The control unit of any train in the network then receives from the fixed installations the last information message received by the fixed installation and deduces therefrom the running speed to adopt. When exchanging information messages of the above kind it is essential, for safety reasons, to be sure that the last message received by the fixed installations corresponds to the last information message sent by the centralized control station. Given the various components involved in transmitting messages, and the fact that there may be relatively great distances between the centralized control station and the fixed installations, it is possible for some messages to suffer interference or to be delayed during transmission and to reach the fixed installations late, so modifying the order in which the fixed installation receives the information messages compared to the order in which they are sent by the centralized control station. In this case the updated information message at the fixed installation no longer corresponds to the last message sent by the centralized control station. Although such phenomena are rare, to ensure traffic safety it is absolutely essential that they are detected.

A standard way to make the transmission of information messages secure is to employ continuous bidirectional exchanges of data so that an information message received by a fixed installation is sent back to the centralized control station, which checks that it corresponds to the information message sent. However, methods of this kind relying on bidirectional exchanges of data use complex processing methods necessitating costly systems at the sender and the receiver.

The object of the present invention is therefore to propose a secure method of exchanging information messages which, in the course of successive unidirectional exchanges of information messages between a sending platform and a receiving platform, ensures that the last message picked up by the receiving platform corresponds to the last message sent by the sending platform, in order to be able to validate correct updating of the information message at the receiving platform.

### SUMMARY OF THE INVENTION

To this end, the invention provides a secure method of exchanging information messages sent successively from a sending platform to a receiving platform which includes:

a) an initialization sequence in which an initialization message containing information relating to a date t₁ for sending a first information message M₁ is exchanged between the sending platform and the receiving platform so that the sending platform and the receiving platform then both know the date t₁ for sending the first information message M₁, and

b) an information message transmission sequence in which:

the information messages are sent successively by the sending platform at given time intervals ΔT_{E} with a sending time tolerance δ (δ<ΔT_{E}) based on a clock specific to the sending platform, so that the first message M₁ is sent at the date t₁ on the clock and the nth message Mₙ is sent at the date tₙ=t₁+(n−1).ΔT_{E}+δ, each message Mₙ being coded by means of a dynamic code Cₙ specific to the date tₙ of sending the message (the information message data is advantageously coded using a code defined as a function of the security criteria of the application, so that the information messages are rendered incomprehensible in the event of a transmission error, for example the SACEM code), and

the messages received by the receiving platform are processed as a function of their reception date tᵣ based on a clock specific to the receiving platform so that the messages received in an observation window Fₙ in the vicinity of tₙ are decoded using a decoding sequence DCₙ adapted to decode the dynamic code Cₙ, the clock of the receiving platform being synchronized to the date t₁ on receiving the first message M₁.

Particular embodiments of the method according to the invention can include one or more of the following features, individually or in any technically feasible combination:

during the initialization sequence a) a coded initialization message M₀ is sent from the sending platform to the receiving platform and a coded initialization message M′₀ is sent from the receiving platform to the sending platform, the initialization messages M₀, M′₀ containing the information relating to the date t₁ for sending the first information message M₁, and the initialization messages M₀, M′₀ being decoded by the sending platform and the receiving platform which then know the date t₁ for sending the first information message M₁;

if the first message M₁ is not received within an allotted time after reception of the initialization message, the clock of the sending platform is automatically synchronized to the date t₁ at the moment corresponding to the end of the allotted time;

the observation window Fₙ corresponds to a time window [t₁+(n−1).ΔT_{E}−ΔT_{F}*ε, t₁+(n−1).ΔT_{E}+ΔT_{F}*(1−ε)], where n is an integer, ≢T_{F} corresponds to the width of the observation window and satisfies the equation ΔT_{F}<ΔT_{E} and ε is from 0 to 1;

a clock synchronization signal is sent regularly by the sending platform between sending messages Mₙ, the synchronization signal being used to correct the frequency or the phase of the internal clock of the receiving platform dynamically in order to reduce the phase or frequency error between the internal clocks of the receiving platform and the sending platform;

the information messages decoded by the receiving platform are transmitted to an information processing module;

the messages received by the receiving platform during an observation window Fₙ are stored sequentially in a memory able to store only one message at a time and only the message stored in the memory at the end of the observation window Fₙ is transmitted to the information processing module; and

the sending platform is part of a centralized control station of a rail traffic supervision and control system, the receiving platform is part of a fixed installation disposed alongside a rail track, and the information processing module is a control unit on board a train circulating on a track section associated with the fixed installation.

Objects, aspects and advantages of the present invention will be better understood from the following description of one particular embodiment of the invention, which is offered by way of non-limiting example and refers to the accompanying drawings.

### BRIEF DESCRIPTION OF THE DRAWINGS

FIG. 1 is a partial diagrammatic representation of a train supervision installation employing a secure method in accordance with the invention of exchanging information messages.

FIG. 2 is a flowchart showing the main steps of a sending method conforming to the secure exchange method according to the invention employed by a sending platform.

FIG. 3 is a flowchart showing the main steps of a processing method conforming to the secure exchange method according to the invention employed by a receiving platform.

FIG. 4 is a timing diagram showing the sending of information messages from the sending platform, the reception of the messages at the receiving platform, and the processing of the messages in conformance with the secure exchange method according to the invention.

To clarify the drawings, only the system components necessary for understanding the invention are shown. The same components carry the same reference numbers if shown in more than one figure.

### DETAILED DESCRIPTION OF THE PREFERRED EMBODIMENTS

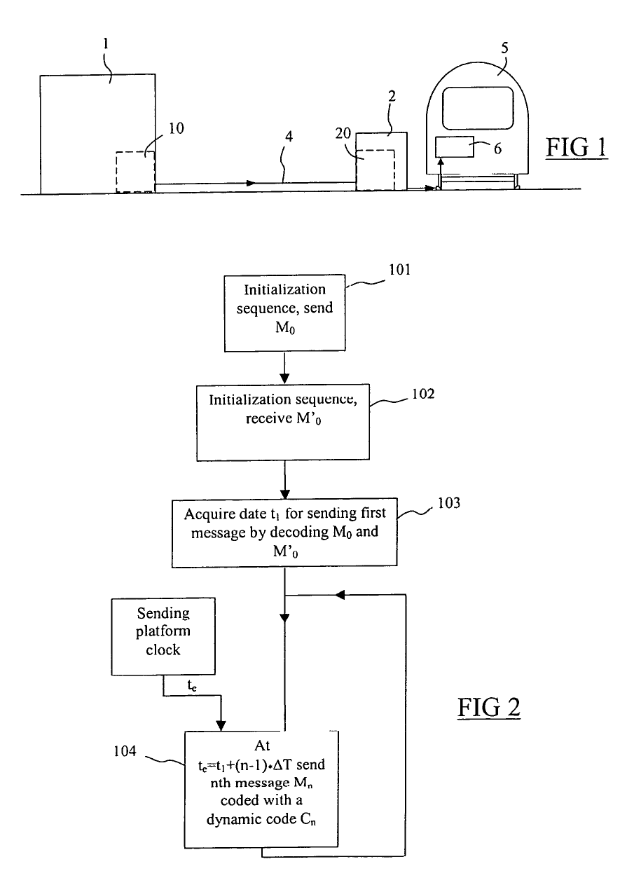

FIG. 1 shows diagrammatically a centralized control station 1 communicating to fixed installations 2 disposed alongside a rail track section information messages including information relating to traffic conditions on one or more track sections downstream of the fixed installation 2. The messages are then transmitted, in a manner that is known in the art, from the fixed installations 2 via a track circuit to a train 5 which carries a control unit 6 which uses the information messages to determine, among other things, how to proceed, for example the speed to adopt or if it is necessary to initiate an emergency stop.

For transmitting the information messages, the centralized control station 1 includes a sending platform 10 connected by transmission cables 4 to a receiving platform 20 in the fixed installation 2. The sending platform 10 and the receiving platform 20 each have an internal clock.

The sequence of information messages sent by the sending platform 10 using the secure exchange method according to the invention is described next with reference to FIG. 2.

In that figure, in a first step 101 of the secure exchange method, an initialization sequence is executed during which a coded initialization message M₀ is transmitted from the sending platform 10 to the receiving platform 20. The message M₀ contains a portion of the information of the initial date of the first information message, for example a random number, generated by the sending platform. In a second step 102, the sending platform receives the message M ₀ sent by the receiving platform. The message M′₀ contains a portion of the information of the initial date of the first information message, for example a random number, generated by the receiving platform. In a step 103 the sending platform 10 decodes the messages M₀, M′₀ to generate the initial date of the first message. An implicit portion can optionally complement the initial date.

The transmission of the initialization sequence is conventionally made secure by executing a bidirectional exchange method to check that the correlation between the received message and the sent message is correct.

The initialization sequence previously described is followed by a step 104 of the method in which no message is sent by the sending platform 10 until the time tₑ on the internal clock of the sending platform 10 reaches the date t₁ for sending the first message M₁. At that date t₁, the sending platform 10 sends the first message M₁, after which messages are sent at constant time intervals ΔT_{E} such that the nth message Mₙ is sent at the date tₙ=t₁+(n−1).ΔT_{E}+δ, where n is an integer and δ is the sending time tolerance (δ<ΔT_{E}).

According to one feature of the invention, each message Mₙ sent is coded with a dynamic code Cₙ specific to the date tₙ for sending the message. The dynamic code Cₙ is of a type chosen from dynamic codes known in the art which have coding properties such that the decoding of the message Mₙ using a decoding sequence other than the decoding sequence DCₙ for decoding the code Cₙ produces a message that is incomprehensible given the coding defined at the level of the application. For example, the code chosen can be a superimposed pseudo-random sequence based on applying to each of the data bits the primitive polynomial X³²+X²²+X²+X+1.

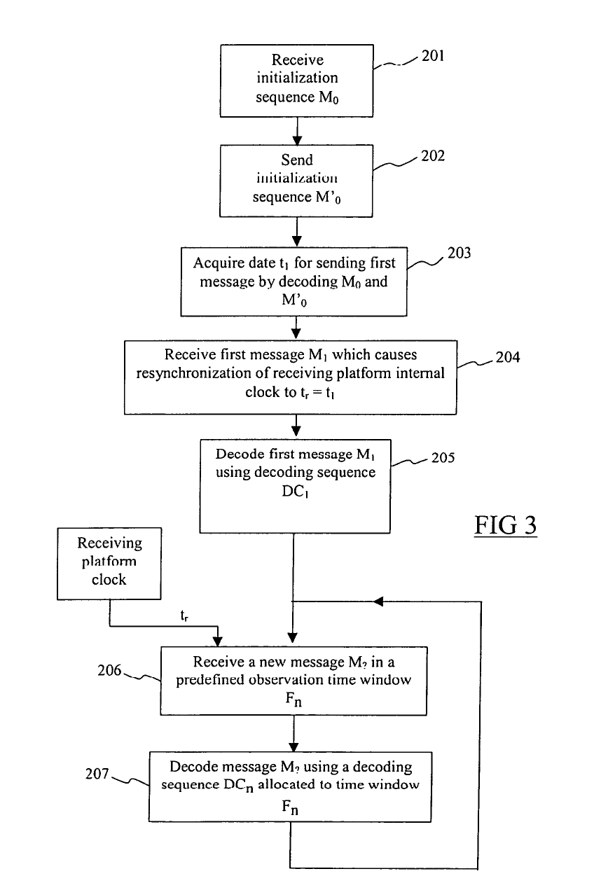

The processing executed in parallel by the receiving platform 20 while the sending platform 10 is sending the sequence of information messages is described next with reference to FIG. 3.

As shown in FIG. 3, in a first step 201 of the method, the receiving platform 20 receives the message M₀ contained in the initialization sequence sent by the sending platform during the step 101. In a second step 202, the receiving platform 20 sends the message M′₀ which is received by the sending platform during the step 102. In a step 203, the messages M₀, M′₀ are decoded by the receiving platform 20 to obtain the initial date t₁ of the first message M₁, as in step 103 of the method as executed at the sending platform.

In a subsequent step 204 of the method, which is triggered when the receiving platform 20 receives the first message M₁, the internal clock of the receiving platform 20 is synchronized to the date t₁ so that tᵣ=t₁ at the time the first message M₁ is received, where tᵣ is the time on the internal clock of the receiving platform 20. The internal clock of the receiving platform 20 is synchronized by default to the date t₁ if the first message M₁ does not reach the receiving platform 20 within an allotted time after reception of the initialization message M₀.

After the message M₁ is received, the clock of the receiving platform 20 is preferably synchronized regularly to the clock of the sending platform 10 using clock synchronization frames sent regularly by the sending platform 10 in the same cycle as the messages Mₙ. These frames are either dedicated frames or the messages Mₙ themselves. Accordingly, if a synchronization error (phase, frequency, average, least squares, etc.) is measured between the internal clock of the sending platform 10 and the internal clock of the receiving platform 20, the frequency or the phase of the internal clock of the receiving platform 20 is corrected dynamically to reduce the phase or frequency error between the two clocks.

During the next step 205 of the method, the first message M₁ received is decoded by means of a decoding sequence DC₁ adapted to decode the dynamic code C₁ and the result of decoding the message M₁ is transmitted to the track circuit by the receiving platform 20.

The next step 206 of the method is triggered iteratively when the receiving platform 20 receives a new message M_{?}, a priori the message Mₙ, at a time tᵣ in an observation time window Fₙ that corresponds to a time window [t₁+(n−1).ΔT_{E}−ΔT_{F}*ε, t₁+(n−1).ΔA_{T}+ΔT_{F}*(1−ε)], where ΔT_{F} is the width of the observation window, n is an integer and ε is from 0 to 1.

During the next step 207 of the method, the message M_{?} received from the sending platform 20 in an observation window Fₙ is decoded using a decoding sequence DCₙ allotted to the observation window Fₙ which corresponds to the inverse coding sequence DCₙ and is adapted to decode only the dynamic code Cₙ of the nth message sent by the sending platform 10.

In a preferred embodiment of the invention, in a step that is not shown in FIG. 3, the message M_{?} decoded by the receiving platform 20 is then stored temporarily in a memory having a capacity such that it is able to store only one message at a time, before being sent to the track circuit at the time tᵣ corresponding to the end of the observation window Fₙ. In a simplified variant, the message M_{?} can be transmitted to the track circuit immediately at the end of the step 207, without being stored in a memory.

The train 5 on the track section then receives, via the track circuit, the messages decoded by the receiving platform 20, with the assurance that the messages M_{?} received, which are comprehensible given the decoding defined in the application, are correctly updated messages Mₙ, the information in which must be acted on. Moreover, to ensure the safety of trains circulating on the track, the control unit 6 on board the train 5 triggers an emergency stop if the train 5 receives a plurality of successive incomprehensible messages, for example five such messages one after the other, with a result that the train is stopped when it no longer has sufficient information on traffic conditions in the downstream track section.

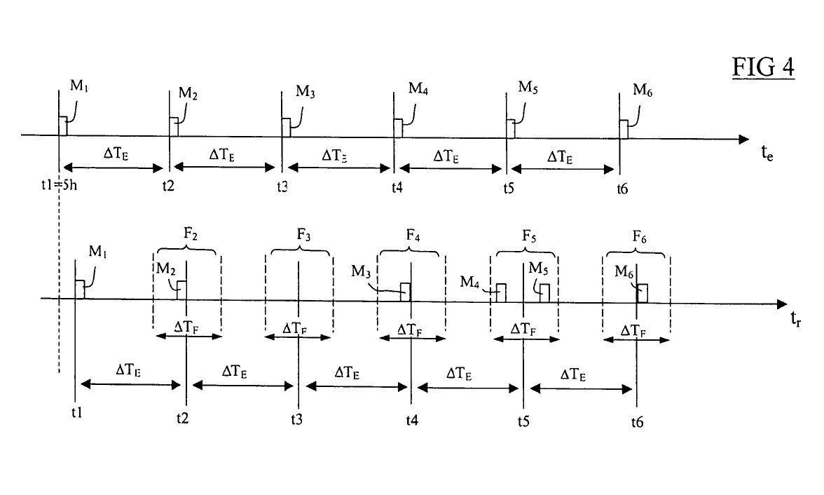

FIG. 4 shows one example of a sequence of information messages exchanging in conformance with a method according to the invention. In this figure, the sending of messages M₁ to M₆ is shown on the top axis tₑ, this axis corresponding to the time on the internal clock of the sending platform 10, and the reception of messages is shown on the axis tᵣ corresponding to the time on the clock of the receiving platform 20. In the example described with reference to FIG. 4, the initialization sequence, not shown in this figure, is considered to be initiated at the time tₑ=4 h59 min and the date t₁ of sending the first message is considered to be t₁=5 h. The interval ΔT_{E} is of the order of a few milliseconds, for example ΔT_{E}=50 ms, with the result that the updating of the information messages is regular. In the example shown, the sending time tolerance δ is zero and the observation windows Fₙ have the characteristics ε=0.5 and ΔT_{F}=25 ms.

Accordingly, referring to FIG. 4, and in particular to the reception of messages shown on the bottom axis tᵣ representing the time on the clock of the receiving platform 20, a few moments after the first message M₁ is sent the receiving platform 20 receives the message M₁. The receiving platform 20 then synchronizes its internal clock so that tᵣ=t₁ at the moment the message M₁ is received. The message M₁ is then decoded by the receiving platform using the decoding sequence DC₁ and is then transmitted to the track circuit and thus to any train 5 on the track section.

A few moments later, the receiving platform 20 receives the message M₂ in an observation window F₂ of width ≢T_{F} centered on t₂. The receiving platform 20 then decodes the message M₂ using the decoding sequence DC₂. The decoded message is stored in a memory of the receiving platform having a capacity able to store only one message at a time and is then transmitted to the track circuit at the time tᵣ corresponding to the end of the observation window F₂: tᵣ=t₂+ΔT_{F}/2. The control unit 6 of the train 5 on the track section is then informed of traffic conditions by the message M₂.

Because of interference affecting the transmission of the message M₃, the receiving platform 20 does not receive any message during the observation window F₃. In this case, the message transmitted by the receiving platform 20 to the track circuit at the time tᵣ corresponding to the end of the observation window F₃ is incomprehensible when decoded by the application, which informs the control unit 6 of the train 5 on the track section of this information message updating error.

In due course the message M₃ is received in the observation window F₄ and is then decoded using the decoding sequence DC₄ allotted to the window F₄, which produces a decoded message that is incomprehensible, given the coding defined by the application and stored in the memory of the receiving platform 20. The incomprehensible message is transmitted to the track circuit at a time tᵣ corresponding to the end of the observation window F₄ and the control unit 6 of the train 5 receives the incomprehensible message and interprets it as another information message updating error. The control unit 6 then registers two successive information message updating errors, but does not yet bring about emergency stopping of the train if the allowed tolerance is five successive errors.

Two messages M₄ and M₅ are received successively by the receiving platform 20 during an observation window F₅. The receiving platform 20 receives the message M₄ first and then the message M₅ in the same observation window F₅. The receiving platform decodes the message M₅ using the decoding sequence DC₅, producing a decoded message that is comprehensible, given the coding defined by the application and stored in the memory of the receiving platform 20 in place of the preceding message. The message M₅ is transmitted to the track circuit at a time tᵣ corresponding to the end of the observation window F₅. The control unit 6 of the train 5 then receives a message which is comprehensible, given the coding defined by the application, i.e. the message M₅, with the assurance that the information contained in that message has been updated correctly.

During an observation window F₆, the receiving platform 20 receives the message M₆, which is decoded using the decoding sequence DC₆ and then stored in the memory before it is sent to the track circuit at a time tᵣ corresponding to the end of the window F₆. The control unit 6 of the train 5 then receives a message that is comprehensible, given the coding defined by the application, i.e. the message M₆, with the assurance that the information contained in the message has been updated.

Thus, thanks to the regular unidirectional exchange of messages between a sending platform and a receiving platform, a secure method of exchanging information messages of the kind described above guarantees correct updating of the information messages that reach the destination in a comprehensible form, without using complex processing. A method of the above kind has the advantage that it is relatively inexpensive to implement and transmits information at high speed, unlike the usual bidirectional transmission systems, in which the information verification sequence considerably slows the transmission of messages, and therefore action taken in response to them. The method according to the invention therefore refreshes information messages received by a train at a relatively high rate.

Of course, the invention is in no way limited to the embodiment described and shown, which is offered by way of example only and can be modified, in particular from the point of view of the composition of the various components or by substituting technical equivalents, without departing from the scope of protection of the invention.

There is claimed:

1. A secure method of exchanging information messages sent successively from a sending platform to a receiving platform, which includes:
a) an initialization sequence in which an initialization message containing information relating to a date t₁ for sending a first information message M₁ is exchanged between said sending platform and said receiving platform so that said sending platform and said receiving platform then know said date t₁ for sending said first information message M₁, and
b) an information message transmission sequence in which:
said information messages are sent successively by said sending platform at given time intervals ΔT_{E} with a sending time tolerance δ based on a clock specific to said sending platform, so that said first message M₁ is sent at said date t₁ on said clock and the nth message Mₙ is sent at the date t₁=t₁+(n−1).ΔT_{E}+δ, each message Mₙ being coded by means of a dynamic code Cₙ specific to said date tₙ of sending said message, and
said messages received by said receiving platform are processed as a function of their reception date tᵣ based on a clock specific to said receiving platform so that said messages received in an observation window Fₙ in the vicinity of tₙ are decoded using a decoding sequence DCₙ adapted to decode said dynamic code Cₙ, said clock of said receiving platform being synchronized to said date t₁ on receiving said first message M₁.

2. The secure method claimed in claim 1 of exchanging information messages, wherein during said initialization sequence a) a coded initialization message M₀ is sent from said sending platform to said receiving platform and a coded initialization message M ₀ is sent from said receiving platform to said sending platform, said initialization messages M₀, M′₀ containing the information relating to said date t₁ for sending said first information message M₁, and said initialization messages M₀, M′₀ being decoded by said sending platform and said receiving platform which then know said date t₁ for sending said first information message M₁.

3. The secure method claimed in claim 1 of exchanging information messages, wherein, if said first message M₁ is not received within an allotted time after reception of said initialization message, said clock of said sending platform is automatically synchronized to said date t₁ at the moment corresponding to the end of the allotted time.

4. The secure method claimed in claim 1 of exchanging information messages, wherein said observation window Fₙ corresponds to a time window [t₁+(n−1).ΔT_{E}−ΔT_{F}*ε, t₁+(n−1).ΔT_{E}+ΔT_{F}*(1−ε)], where ΔT_{F} corresponds to the width of the observation window and satisfies the equation ΔT_{F}≦ΔT_{E} and ε is from 0 to 1.

5. The secure method claimed in claim 1 of exchanging information messages, wherein a clock synchronization signal is sent regularly by said sending platform between sending messages Mₙ, said synchronization signal being used to correct the frequency or the phase of the internal clock of said receiving platform dynamically in order to reduce the phase or frequency error between the internal clocks of said receiving platform and said sending platform.

6. The secure method claimed in claim 1 of exchanging information messages, wherein said information messages decoded by said receiving platform are transmitted to an information processing module.

7. The secure method claimed in claim 1 of exchanging information messages, said messages received by said receiving platform during an observation window Fₙ are stored sequentially in a memory able to store only one message at a time and only the message stored in said memory at the end of said observation window Fₙ is transmitted to said information processing module.

8. The secure method claimed in claim 1 of exchanging information messages, wherein said sending platform is part of a centralized control station of a rail traffic supervision and control system, said receiving platform is part of a fixed installation disposed alongside a rail track, and said information processing module is a control unit on board a train circulating on a track section associated with said fixed installation.
